(19) United States
(12) Patent Application Publication
(10) Pub. No.: US 2022/0414605 A1
(43) Pub. Date: Dec. 29, 2022

(54) Computer Enabled Business Method for Quality Checking and Classifying Third Party Data

(71) Applicant: Payscale, Seattle, WA (US)

(72) Inventor: Jesse WHITE, Seattle, WA (US)

(73) Assignee: Payscale, Seattle, WA (US)

(21) Appl. No.: 17/844,202

(22) Filed: Jun. 20, 2022

Related U.S. Application Data
(60) Provisional application No. 63/212,285, filed on Jun. 18, 2021.

(51) Int. Cl. G06Q 10/10

(52) U.S. Cl. CPC G06Q 10/1053

(57) ABSTRACT

Business and automation methods relating to management of education, salary and other employment data are provided. According to one aspect of the invention, a computer enabled business method for checking quality and classifying third party education and other employment data is provided that filters, transforms ins and dynamically improves the basic functionality of a computer with respect to associated data management.

### FIELD

The present invention relates generally to business and automation methods relating to management of education, salary and other employment data, and in a particular though non-limiting embodiment to a computer enables business method for checking quality and classifying third party education and other employment data.

### BACKGROUND

Historically, salary and other compensation data are sourced entirely from third parties, for example, from individuals who submit individual job data to contribute to a crowdsourced data set, and from the employees of participating customers that have employment-related information included in a compensation survey. It is therefore not possible to selectively determine the quality of incoming data, and/or to group or classify the data since the incoming data varies greatly.

### SUMMARY

The solution disclosed herein comprises a custom rules engine used to classify and activate data. In one example embodiment, the custom rules engine is powered by logical rules. Since data is always suspect when it comes from a third party, the method applies a nested hierarchy of rules for the third party data to flow through.

Flowing through this hierarchy of rules improves evaluation of the quality of incoming data. Subsequently, a hierarchical rules-based method groups similar data together (for example, jobs located in townships or suburbs surrounding Seattle can be grouped under a single Seattle location if desired). By applying the hierarchical ruleset to incoming data, data can be parsed in seemingly limitless levels of granularity. as different segments of a data set can be combined together to yield predictive results based on rollups to higher level categories.

For example, if the owner of a small suburban engineering firm is considering hiring an extremely skilled engineer, there may be insufficient relevant information to predict what an especially skilled engineer might earn in another location.

According to one example embodiment, if a user statistically rolls up the entirety of the category, and furthermore expands the definition of extremely skilled engineers as being closest in nature to executive engineers, a user is able to better predict what similar positions should earn in other locations.

The inventive principle can be applied to many other contexts, for example, by job industry, title, and so forth. In this manner, the user can absorb and utilize massive amounts of third party data in a safe and considered manner.

The disclosed method of grouping and classifying varied incoming data is a novel and inventive method of solving a classical problem. The variable and scalable custom solution results in higher quality and more useable than any other data sets that exist in the human resources compensation space. Most beneficially, the hierarchical set of nested rules can be applied to virtually any other context where data is harvested and characterized. An associated system of use reorganizes existing data when changes to the roles or desired structure changes.

For example, if a modification is made to the hierarchical ruleset that was used to parse the original data, that modified hierarchical ruleset will be applied both going forward and retroactively to all data that was parsed through it. According to one example embodiment, if a ruleset is modified such that extremely skilled engineers in a suburb of Seattle should be classified as executive engineers in Washington, that ruleset will apply automatically be applied retroactively and going forward to all extremely skilled engineers in a suburb of Seattle.

The attached illustration of supplemental material, the entirety of which is incorporated by reference, illustrates a detailed though non-limiting example embodiment in which various inputs are presented in line with the requirements of this disclosure. Ordinarily skilled artisans will readily appreciate, however, that different input criteria, geographically bundled data combinations, and even presently contemplated software packages minimally capable of running the program, can all be replaced or substituted, added to, or deleted from, all without departing from the scope of the disclosure.

Though the present invention has been depicted and described in detail above with respect to several exemplary embodiments, those of ordinary skill in the art will also appreciate that minor changes to the description, and various other modifications, omissions and additions may also be made without departing from either the spirit or scope thereof.

1. A business and automation method relating to management of education, salary and other employment data, said method comprising:
filtering incoming third party data so that it is analyzed for content and form; and
transforming the analyzed data into a single standardized platform regardless of it's native platform; and
storing the analyzed and transformed data in both a native and a transformed state.
